(19) United States
(12) Patent Application Publication
(10) Pub. No.: US 2023/0234507 A1
(43) Pub. Date: Jul. 27, 2023

(54) Exterior rear view assembly for road vehicles and method of manufacturing an exterior rear view assembly for road vehicles

(71) Applicant: MOTHERSON INNOVATIONS COMPANY LIMITED, London (GB)

(72) Inventor: Hans-Dieter Pomparew, Esslingen am Neckar (DE)

(21) Appl. No.: 18/158,589

(22) Filed: Jan. 24, 2023

(30) Foreign Application Priority Data
Jan. 25, 2022 (DE) 102022200782.4

(51) Int. Cl. B60R 1/12; B60R 1/02

(52) U.S. Cl. CPC B60R 1/12; B60R 1/02; B60R 2001/1223

(57) ABSTRACT

Exterior rear view assembly for road vehicles and method of manufacturing an exterior rear view assembly for road vehicles

The present invention provides an exterior rear view assembly for road vehicles. The assembly comprises: a first plate element; a second plate element having essentially a similar form as and extending essentially in parallel to the first plate element; and a core element arranged sandwiched between the first plate element and the second plate element, wherein the first plate element, the core element and the second plate element together form a joint part comprising a coupling section configured to be coupled to a vehicle body in an articulated manner. Furthermore, the invention provides a corresponding method of manufacturing an exterior rear view assembly for road vehicles.

### CROSS-REFERENCE TO RELATED APPLICATION

This application claims priority to German Patent Application No. 102022200782.4, filed on Jan. 25, 2022, the content of which is hereby incorporated by reference in its entirety.

### FIELD OF THE INVENTION

The present invention relates to an exterior rear view assembly for road vehicles and method of manufacturing an exterior rear view assembly for road vehicles.

### BACKGROUND OF THE INVENTION

Road vehicles are required to have exterior rear view systems, which allow the driver to observe the surroundings of the vehicle, which are outside of the driver's peripheral vision. In order to enable the driver to observe the surroundings, the exterior rear view systems are mounted to the exterior of road vehicles. The surroundings of the vehicle include the rear of the vehicle as well as the left and right side of the vehicle. Furthermore, some exterior rear view systems are configured to effectively cover the blind spot(s) of the driver.

Exterior rear view systems usually employ some sort of reflective surface, in particular mirror, or a camera system. Furthermore, exterior rear view systems, especially systems for housing a camera system, are configured to be attached to a vehicle body and carry a multitude of connectors, sensors and/or actuators in order to ensure a proper functionality.

Document DE 10 2019 204 419 B3 describes a camera arm device for a mirror replacement system of a motor vehicle. The device contains a boom member that has a hollow body portion with a corresponding volume that is capable of storing a fluid medium. The device is capable of being in a first condition wherein the boom member is filled with the fluid medium and is approximately orthogonal to the vehicle and a second condition wherein the boom member is not filled with the fluid medium and is approximately alongside the vehicle body.

### SUMMARY OF THE INVENTION

In view of the above, an object of the present invention is to provide a new and improved exterior rear view assembly for road vehicles.

In accordance with the present invention, an exterior rear view assembly for road vehicles as recited in claim 1 and a method of manufacturing as recited in claim 14 are provided. Advantageous or preferred features of the invention are recited in the dependent claims.

According to one aspect, therefore, the present invention provides an exterior rear view assembly for road vehicles, comprising: a first plate element; a second plate element having essentially a similar form as and extending essentially in parallel to the first plate element; and a core element arranged sandwiched between the first plate element and the second plate element, wherein the first plate element, the core element and the second plate element together form a joint part comprising a coupling section configured to be coupled to a vehicle body in an articulated manner.

In this way, the invention provides an assembly that is configured as sandwich structure, which results in a high strength- and a stiffness-to-weight ratio. The core element may comprise a polymer material, preferably a glass fiber free thermoplastic polymer configured for automotive applications, and the plate elements may comprise a metal material, for example a light weight metal alloy configured for automotive applications. In this way, advantageously, use of glass fiber can be fully avoided and recyclability of a rear view assembly is improved. Additionally, the assembly can achieve these characteristics, while having a low density. In this way, the invention is ideally constructed to provide a stable, spacious and well recyclable rear view assembly for road vehicles.

The present invention proposes constructing the assembly from a central core element with two parallel first and second plate elements, which essentially have a similar form. The plate elements may encapsulate the core element on opposing sides of the core element. Additionally, the assembly avoids being bulky and/or heavy, which would have negative effects on wind resistance and overall efficiency of the road vehicle. Furthermore, the assembly is highly versatile and can provide an ideal base for contour-defining costumer designed exterior rear view assembly covers. Furthermore, the core element leaves design freedom for easy integration of electronic elements, such as sensors, wirings, telecommunication modules, control devices, or the like.

The joint part, consisting of the core element and the first and second plate elements, additionally comprises a coupling section, which is configured to articulate with a vehicle body. In particular, the articulation of the assembly through the joint part to the vehicle body can be of a nature that is typical in automotive engineering, wherein the assembly can be folded to and from the vehicle body as required by the driver in order to adapt the width of the vehicle. Especially, the coupling section is formed, at least in part, integrated with the first plate element, the core element and the second plate element. For example, it is therefore possible to adapt the position of the assembly when the road vehicle is parked or in an automated car wash.

In a preferred embodiment, the core element comprises a carrier section configured to carry and electronically contact an electronic rear view sensor. In particular, the electronic rear view sensor can be a camera that is suitable for capturing images/video in an environment, which is typical to road vehicles. Accordingly, the exterior rear view assembly can be used as an alternative to mirror based systems. In particular, the carrier section can be configured to accommodate a series of connectors in order to electronically contact the electronic rear view sensor.

In an embodiment, the first plate element and/or second plate element has a first thickness and the core element has a second thickness, which is a multiple of the first thickness. Accordingly, the core element makes up the majority of the thickness of the assembly and the first plate element and second plate element function as significantly thinner covers on opposing sides of the core element. In this way, an assembly is provided which employs function-oriented parts, wherein the core element can be configured to house a variety of different components and the plate elements serve as boundaries and/or covers.

In a particularly preferred embodiment, the core element comprises an integral wiring guide, in particular a wiring channel, for guiding a cable harness from the coupling section to the carrier section. In this way a guiding mechanism is provided to accommodate the communication means of the electronic rear view sensor from the carrier section to the coupling section and vice versa. In particular, the integral wiring guide may be formed specifically to protect the cable harness from environmental conditions and/or during shocks and vibrations, which are typical to the operation of a road vehicle. Accordingly, the integral wiring guide may be formed as a lane running along the perimeter of the core element from the coupling section to the carrier section. The wiring guide can be dimensioned to correspond to the size of the cable harness. Additionally, the cable harness can be configured to contain multiple wires of different lengths or diameters with different plugs relating to different functions of the electronic rear view sensor or other suitable devices, sensors or actuators. In particular, the cable harness can be configured to electronically contact the electronic rear view sensor.

In a further embodiment, the joint part is configured as cantilever arm that can be articulated and protrude from the coupling section in a vehicle outboard direction such that the electronic rear view sensor is arranged in a position spaced from the vehicle body. The positioning of the electronic rear view sensor spaced from the vehicle body enables the sensor to pick up the areas behind and to side of the vehicle. In particular, the electronic rear view sensor can pick up the areas outside of the drivers peripheral vision. In this way, the electronic rear view sensor can observe a far greater amount of surrounding area, rather than if it were mounted directly on the vehicle body without any sufficient spacing.

The outboard direction is oriented approximately crosswise to the vehicle driving direction and simultaneously away from the centre of the vehicle. Accordingly, “vehicle outboard direction” is to be understood as a direction outboard with respect to the vehicle body.

In a preferred embodiment, the core element comprises an integrated plug retaining section configured to fix at least one plug of the cable harness in a predetermined position in the coupling section or in the immediate vicinity of the coupling section. In this way a designated area is provided, which is configured for contacting the plugs of the cables contained in the cable harness. Furthermore, the close proximity of the plug retaining section to the coupling section reduces the necessary total length of the cable harness to a minimum. In this way, weight and material use of the assembly are reduced. Accordingly, it is not necessary to guide the cables the entire distance from the electronic rear view sensor to the component that processes the signals of the sensor. Additionally, the integrated plug retaining section provides a useful interface, which increases modularity and flexibility of the assembly.

In a further preferred embodiment, the core element comprises a sealing side cover covering an outer side area of the core element. In particular, the sealing side cover is essentially positioned on the lateral sides of the core element, which are not covered by the first and second plate element. In this way, the core element is at least partially encapsulated by the first plate element, second plate element and sealing side cover. The sealing side cover in particular comprises a polymer material; preferably, a glass fiber free thermoplastic polymer configured for automotive applications, such as acrylonitrile butadiene styrene (ABS) or a copolymer thereof. In this way, advantageously, use of glass fiber is fully avoided and recyclability of the rear view arrangement is improved.

In a particularly preferred embodiment, the sealing side cover is configured as a sealing barrier extending around the perimeter of the core element and sealing against the first plate element and the second plate element such that the core element is sealed against an exterior environment. In this way, the core element and all of the contained elements, in particular the cable harness, are sealed off from different external factors. Further electronic elements can be easily integrated in the sealed space. The type of sealing may vary based on the application of the assembly and may be configured as but is not limited to waterproof or even hermetic (airtight) sealing, sealing against solid particles and/or liquid ingress protection. The sealing side cover may seal against the first plate element and second plate element, for example by means of a lip or flange or additional sealing material or other suitable sealing element.

In a particularly preferred embodiment, the sealing side cover, first plate element and second plate element together create a sealed internal cavity. In particular, the sealed internal cavity is created by mounting the core element comprising the sealing side cover, the first plate element and the second plate element together. In this way, it is possible to accommodate and simultaneously protect functional elements, mechanically sensitive components and/or electrically sensitive components, such as a variety of electronics, sensors, circuit boards and/or integrated circuits (IC) within the sealed internal cavity. The dimension of the sealed internal cavity is defined by the size of the first plate element and second plate element and the distance between the first plate element and second plate element.

In a further preferred embodiment, at least one of the first and second plate elements comprises at least one centering element and the core element comprises at least one counter centering element. The centering and counter centering elements are arranged and configured to align the first plate element and/or second plate element with the core element in a predetermined position relative to each other. In this way, an assembly with a simple and cost effective centering system is provided. In particular, multiple centering and counter centering elements may be displaced about the first plate element, second plate element and/or core element respectively. In an embodiment, the centering and counter centering elements can be configured as pins and notches respectively. Furthermore, in an embodiment, a clip system can be employed to preliminarily fixate the joint part together after centering.

In a preferred embodiment, at least one of the first and second plate elements comprises at least one fastening element configured to fasten the first plate element, the second plate element and the core element in a predetermined position relative to each other. In this way the first plate element, second plate element and core element form a rigid structure with a high strength. Accordingly, the joint part exhibits a high stiffness and resistance to damage, in particular after being fastened.

In a preferred embodiment, the core element comprises a bearing recess arranged in the coupling section. Alternatively or in addition, the coupling section comprises an articulation axis protruding from the first plate element or second plate element into the core element. The articulation axis is in particular fixed to or formed integrated with the first plate element or second plate element. The bearing recess in the core element provides an integrated and cost effective bearing function and may be formed as a long cylindrical bearing manufactured from the core element material and/or another polymer material. The assembly can additionally employ bushings to improve the bearing of the articulation axis in the bearing recess of the core element. The articulation axis acts as a rotational axis around which the assembly can rotate. The orientation of the articulation axis may be picked freely according to design or engineering requirements. In particular, the fixation of the articulation axis may be realized by the means of knurling at least a portion of the surface of the articulation axis and creating an engineered fit between the first plate element and/or second plate element and the knurled surfaces of the articulation axis. In an embodiment, the articulation axis is formed as a knurled axis pressed-in with an aperture of the first plate element and/or second plate element. The articulation axis can also be fastened to the first plate element and/or second plate element by means of fastening elements, for example screws, pins and/or nuts or a combination thereof.

In a further embodiment, the assembly comprises an intermediary joint, which is configured to be in contact with the core element. Furthermore, the intermediary joint may provide actuators and/or sensors to actuate the rotation of the assembly with respect to the articulation axis. Additionally, the intermediary joint may provide the basis for coupling the assembly to a vehicle body. In this way, the intermediary joint provides additional modularity and enables a flexible use of the assembly in combination with a variety of vehicle bodies. In an embodiment, the intermediary joint may be manufactured by die-casting. Since the articulation axis is supported by the bearing recess in the core element, first plate element and second plate element, the intermediary joint does not require any mechanical finishing that is usually required if the die-casted intermediary joint would be in contact with the articulation axis directly.

In a particularly preferred embodiment, the first plate element and/or second plate element comprises a shielding metal material, in particular aluminium. In this way, the core element is shielded from damage by typical external impacts during the use of the road vehicle. In particular, the first plate element and/or second plate element are manufactured by die-casting. Accordingly, two of the largest components of the assembly may be manufactured as single pieces, which saves time and costs with respect to tooling and assembly.

In a preferred embodiment, the core element is formed as a hollow body, in particular comprising reinforcing ribs. In this way, the largest component of the assembly has a low density, which enables the assembly to have a low weight despite its size. Furthermore, the reinforcing ribs increase the rigidity of the core element and additionally protect the internal components from damage.

In a preferred embodiment, the cable harness may be configured as a power supply and control line, e.g. for a camera actuator, a camera heating or the like. Other examples for functions and devices incorporated into and/or controlled with the help of rearview devices that may be supplied and/or controlled by means of the cable harness and/or integrated in the rear view assembly comprise also illumination devices, for example any kind of light module like an external light module, an internal light module, a front light, a back light, a fog light, a brake light, an acceleration light, a turn signal, a logo lamp, a front area illumination light, a ground illumination light, a puddle light, a flash light, a navigation light, a position light, an emergency light, a spotlight, a green light, a red light, a warning light, a turn signal light module, an approach light, a search light, an information light, a display and/or any combination thereof. Further examples for functions and devices incorporated into and/or controlled with the help of rearview devices that may be supplied and/or controlled by means of the cable harness can comprise for example a tiredness detection system, a microsleep detection system, a distance and/or velocity determination system, for example a LIDAR (Light detection and ranging) system, a blind spot indicator system, a lane change assistant system, a navigation assistant system, a tracking assistant system, a human-machine interaction system, a machine-machine interaction system, an emergency and precaution assistant system, like an accident avoiding assistant system, a counter-measures assistant system, a brake assistant system, a steering assistant system, an acceleration assistant system, an escape assistant system, comprising for example an ejection seat system, a direction indicator, a blind spot indicator, an approach system, a strong braking system, an emergency braking system, a charging status indicator, a vehicle mode system, comprising for example a sports mode system, an economy mode system, an autonomous drive mode system, a sleep mode system and an anti-theft system, a vehicle locked indicator system, a vehicle stolen indicator, a warning signal system, a temperature indicator system, a weather indicator system, a traffic light signal system, a fuel status system and/or any combination thereof.

According to another aspect, the invention provides a method of manufacturing an exterior rear view assembly for road vehicles, in particular an exterior rear view assembly according to the invention, comprising the steps of: arranging a core element on a first plate element in a predetermined position relative to the first plate element; guiding a cable harness by means of an integral wiring guide of the core element from a coupling section of the core element, which is configured to be coupled to a vehicle body, to a carrier section of the core element, which is configured to carry and electronically contact an electronic rear view sensor; arranging a second plate element on the core element in a predetermined position relative to the core element; and stiffly fixing the first plate element, core element and second plate element to each other.

As discussed above, the invention provides an assembly that is configured as sandwich structure, which results in a high strength- and a stiffness-to-weight ratio. The sandwich structure is established through a method comprising firstly arranging the core element on a first plate element and subsequently arranging a second core element on said core element. The first plate element and/or second plate element are arranged in a predetermined position with respect to the core element. The predetermined positioning of the parts in relation to each other can be ensured by the means of form fitting, e.g. by the means of a poke-yoke configuration of the parts. In this way a cost-effective option is provided, which avoids an incorrect arrangement of parts.

Additionally, during the assembly, the core element provides an integral wiring guide for effectively guiding the cable harness, without any further steps or tools. In this way, the invention is ideally constructed to provide an all-in-one construction and easy manufacturing, which does not require any further add-on components or steps, for example in order to guide a cable harness. The integral wiring guide is configured to guide the cable harness from the coupling section, located towards the vehicle body, safely through the core element in the direction of the carrier section and finally to the electronic rear view sensor. Accordingly, the cable harness is guided directly within the core element and additionally can be shielded by the first plate element and second plate element on either side of the core element. In this way, the potentially sensitive cable harness is effectively protected from external impacts. The same applies to any additional electronic components which may be integrated into the core element (see above list of examples for functions and devices that can be incorporated).

Additionally, the first plate element, second plate element and core element are stiffly fixed to each other. In this way, the main components of the assembly are fixed to each other in order to be safely handled in an automotive assembly setting. For example, an automotive assembly line worker can securely attach the assembly to a vehicle body, without having to be wary of spontaneous disassembly.

Furthermore, the assembly is highly versatile and can provide an ideal base for contour-defining costumer designed exterior rear view assembly covers. For example, the first plate element and/or second plate element may provide attachment points or other form fitting components, which are configured to receive a variety of contour-defining costumer designed exterior rear view assembly covers. In this way, customisation can be easily integrated in the manufacturing process.

In a preferred embodiment, the method further comprises fixing at least one plug of the cable harness in an integrated plug retaining section of the core element in a predetermined position. In this way, plugs of the cables contained in the cable harness are bundled within the plug retaining section of the core element in an organized fashion. Accordingly, in the case of damage or the necessity of repair, a technician can control the plug retention area for trouble shooting the connections.

In a particularly preferred embodiment of the method, arranging the core element on the first plate element or arranging the second plate element on the core element or both comprises pre-fixing the core element and the plate element by means of a clip connection. Alternatively or in addition stiffly fixing the first plate element, core element and second plate element comprises fixing them to each other with a plurality of fastening elements. In this way, the joint part can be pre-fixed before the components are stiffly fixed together with fastening elements. Accordingly, adjustments can still be made in the pre-fixed state of the joint part without having to remove any fastening elements.

The above embodiments can be combined with each other as desired, if useful. Further possible embodiments, further configurations and implementations of the invention also include combinations, not explicitly mentioned, of features of the invention described herein with respect to the embodiments. In particular, the skilled person will thereby also add individual aspects as improvements or additions to the respective basic form of the present invention.

### BRIEF DESCRIPTION OF THE DRAWINGS

For a more comprehensive understanding of the invention and the advantages thereof, exemplary embodiments of the invention are explained in more detail in the following description with reference to the accompanying drawing figures, in which like reference characters designate like parts and in which:

FIG. 1 is a schematic perspective view of an exterior rear view assembly;

FIG. 2 is a detailed side view of an exterior rear view assembly according to an embodiment;

FIG. 3 is a detailed top view of an exterior rear view assembly according to FIG. 2;

FIG. 4 is a detailed sectional view of an exterior rear view assembly according to FIG. 3 along the sectional line “A-A” of FIG. 3;

FIG. 5 is a detailed perspective view of an exterior rear view assembly according to FIG. 2;

FIG. 6 is a detailed top view of an exterior rear view assembly according to FIG. 2;

FIG. 7 is a detailed perspective view of an exterior rear view assembly according to another embodiment;

FIG. 8 is a detailed top view of an exterior rear view assembly according to FIG. 7;

FIG. 9 is a detailed top view of a first plate element;

FIG. 10 is a perspective view of a first plate element and second plate element;

FIG. 11 is a detailed partial view of an exterior rear view assembly according to FIG. 7;

FIG. 12 is a detailed perspective view of an articulation axis and a core element; and

FIG. 13 is a detailed top view of an exterior rear view assembly according to another embodiment.

The accompanying drawings are included to provide a further understanding of the present invention and are incorporated in and constitute a part of this specification. The drawings illustrate particular embodiments of the invention and together with the description serve to explain the principles of the invention. Other embodiments of the invention and many of the attendant advantages of the invention will be readily appreciated as they become better understood with reference to the following detailed description.

It will be appreciated that common and/or well understood elements that may be useful or necessary in a commercially feasible embodiment are not necessarily depicted in order to facilitate a more abstracted view of the embodiments. The elements of the drawings are not necessarily illustrated to scale relative to each other. It will further be appreciated that certain actions and/or steps in an embodiment of a method may be described or depicted in a particular order of occurrences while those skilled in the art will understand that such specificity with respect to sequence is not actually required. It will also be understood that the terms and expressions used in the present specification have the ordinary meaning as is accorded to such terms and expressions with respect to their corresponding respective areas of inquiry and study, except where specific meanings have otherwise been set forth herein.

### DETAILED DESCRIPTION OF EMBODIMENTS

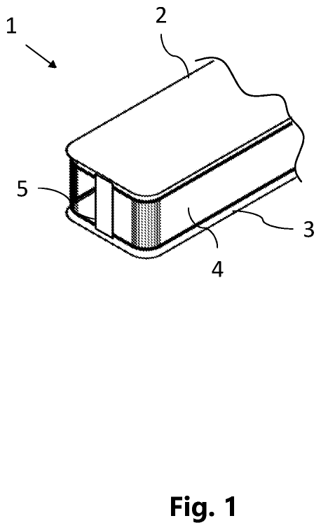

With reference to FIG. 1 of the drawings, an exterior rear view assembly 1 for road vehicles is illustrated schematically. The assembly 1 is schematically shown in part and includes a first plate element 2, second plate element 3, core element 4 and coupling section 5.

The first plate element 2 and second plate element 3 essentially have a similar form. Additionally the first plate element 2 and second plate element 3 are essentially arranged in parallel to each other. In the pictured embodiment, the first plate element 2 and second plate element 3 have a symbolic rectangular form with rounded corners, of course the form can be adapted to a vehicle body. Accordingly, the first plate element 2 and second plate element 3 have lateral sides, wherein the coupling section 5 is, for example only, arranged at a shorter side between the longer sides.

The core element 4 is arranged sandwiched between the first plate element 2 and the second plate element 3. The pictured core element 4 has a similar form with a slightly smaller perimeter, but a greater thickness than the first plate element 2 and/or second plate element 3. Together the first plate element 2, the core element 4 and the second plate element 3 form a joint part. The joint part comprises the coupling section 5, which in the present example is arranged on the shorter side of the first plate element 2, second plate element 3 and core element 4. The coupling section 5 is configured to be coupled to a vehicle body (not shown) in an articulated manner. As a result, the assembly is coupled to a vehicle body in an articulated manner, similarly to a rear view mirror in a conventional road vehicle. For example, the articulation through the coupling section 5 can be realized as a pivot joint. Therefore, the coupling section 5 may be configured to form a pivot joint.

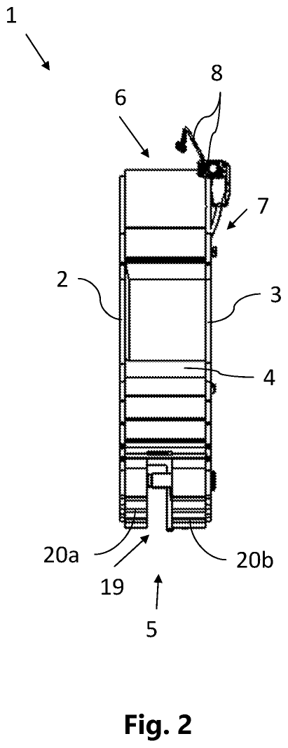

With reference now also to FIG. 2 of the drawings, a detailed side view of an exterior rear view assembly 1 according to an embodiment is shown. The assembly 1 includes a first plate element 2, second plate element 3 and a core element 4.

The positional relationship of the components of the first plate element 2, second plate element 3 and core element 4 of this embodiment is analogous to the one displayed and described in relation to FIG. 1. Accordingly, the joint part comprises a coupling section 5 and the assembly includes a carrier section 6. The carrier section 6 is configured to carry and electronically contact an electronic rear view sensor 17 (not shown). Furthermore, the core element 4 comprises an integral wiring guide 7 for guiding a cable harness 8 from the coupling section 5 to the carrier section 6. For example, the integral wiring guide 7 can be realized as a wiring channel for guiding the cable harness 8. In the present embodiment, the cable harness 8 is shown as a flat or ribbon cable with multiple plugs of different sizes at its distal ends.

In the example shown, the coupling section 5 is formed as a recess 19 in the core element 4. The recess 19 having approximately a rectangular form, extending from the free end of the core element 4 towards the centre of the core element 4. Accordingly, the core element 4 exhibits two opposing sidewalls 20a, 20b on either side of the recess 19. The sidewalls 20a, 20b in the present example have different thicknesses. The recess 19 is configured to enable the assembly 1 to avoid a collision of different parts when the core element 4 rotates.

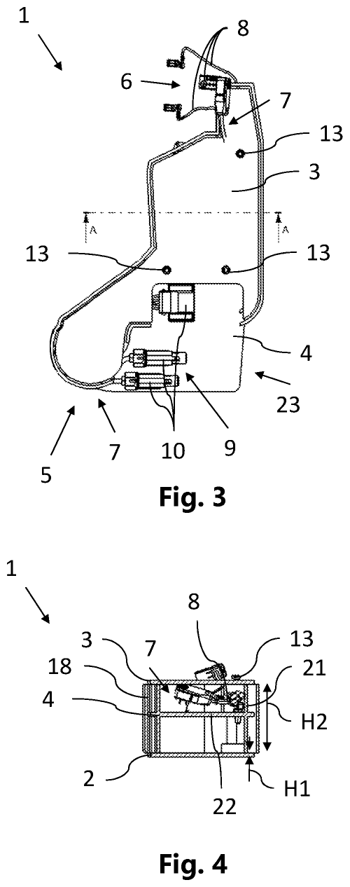

With reference to FIG. 3, a detailed top view of an exterior rear view assembly 1 according to FIG. 2 is shown.

The joint part is configured as cantilever arm that can be articulated and protrude from the coupling section 5 in a vehicle outboard direction such that the electronic rear view sensor 17 (not shown) in the carrier section 6 is arranged in a position spaced from the vehicle body (not shown). In the example shown, the space between the carrier section 5 and coupling section 6 is defined by the length of the longer side of the first plate element 2 (not shown) and/or second plate element 3. Additionally, the core element 4 comprises an integrated plug retaining section 9 configured to fix at least one plug 10 of the cable harness 8 in a predetermined position in the coupling section 5 or in the immediate vicinity of the coupling section 5. In the example shown, there are three plugs 10 fixed in the plug retaining section 9. The plugs 10 are approximately parallel to each other with a slight offset. Accordingly, the entrance/exit of the integral wiring guide 7 is in close proximity to the plug retaining section 9 or carrier section 6.

Additionally the second plate element 3 exhibits an aperture 23 corresponding to the plug retaining section 9 of the core element 4. The aperture 23 is configured to enable access to the plug retaining section 9 through the second plate element 3, in the present example the aperture 23 is realized as a cutout of the second plate element 3. In other embodiments, there may be no requirement for an aperture 23 because the plug retain section 9 may be located in a different location.

In the shown example, the cable harness 8 comprises three cables, which are configured to be attached to a rear view sensor 17 (not shown) in the carrier section 6. Additionally, three fastening elements 13 are depicted in the second plate element 3. These fastening elements 13 are configured to fasten the first plate element 2, second plate element 3 and core element 4 in a predetermined position relative to each other. The fastening elements 13 are depicted as screw heads in the shown example, but can be realized as any suitable fastening means. Additionally, the amount of fastening elements is merely exemplary and can be selected as required. Of course, the number of cables can be adapted to the requirements of the application.

With reference to FIG. 4, a detailed sectional view of an exterior rear view assembly 1 according to FIG. 3 is shown.

The sectional view shows the exterior rear view assembly 1 in a vertical plane along the sectional line “A-A” of FIG. 3.

The first plate element 2 and/or second plate element 3 has a first thickness H1 and the core element 4 has a second thickness H2. The second thickness H2 is a multiple of the first thickness H1. In the shown example approximately a multiple of ten. Accordingly, the core element 4 makes up the majority of the thickness of the assembly 1 and the first plate element 2 and second plate element 3 function as significantly thinner covers on opposing sides of the core element 4. Furthermore, the core element 4 is formed as a hollow body, in particular with a base layer and walls extending therefrom and/or with reinforcing ribs.

This means that the joint part, consisting of first plate element 2, second plate element 3 and core element 4, has a low density. Accordingly, a significant amount of the volume between the first plate element 2 or second plate element 3 and the core element 4 is not occupied and therefore may be configured to accommodate different components. The sandwiched structure of the first plate element 2, second plate element 3 and core element 4 results in a high rigidity. Furthermore, in order to achieve this, the core element 4 comprises multiple spacers 21 that are configured to space the first plate element 2 and second plate element 3 from each other and the core element 4. As shown in the example, the spacers 21 are arranged in close proximity to the distal ends of a central plane 22 of the core element 4. The spacers 21 extend approximately orthogonal from the central plane 22.

In the sectional view of the shown embodiment, the cable harness 8 is guided in the integral wiring guide 7, which lies between the second plate element 3 and the core element 4. Additionally, the spacers 21 designated for contact with the first plate element 2 have a larger length than the spacers 21 designated for contact with the second plate element 3. The head of fastening element 13, which is depicted as a screw, is also shown.

Furthermore, the core element 4 comprises a sealing side cover 18 covering an outer side area of the core element 4. In the shown example and due to the sectional view of FIG. 4, the sealing side cover 18 is only depicted on either side of the core element 4. Moreover, the sealing side cover 18 is configured as a sealing barrier extending around the perimeter of the core element 4 and sealing against the first plate element 2 and the second plate element 3 such that the core element 4 is sealed against an exterior environment. The form of the sealing side cover 18 can exhibit a lip or flange to further seal against the first plate element 2 and/or second plate element 3. The lip or flange may also be arranged as part of the first plate element 2 and/or second plate element 3.

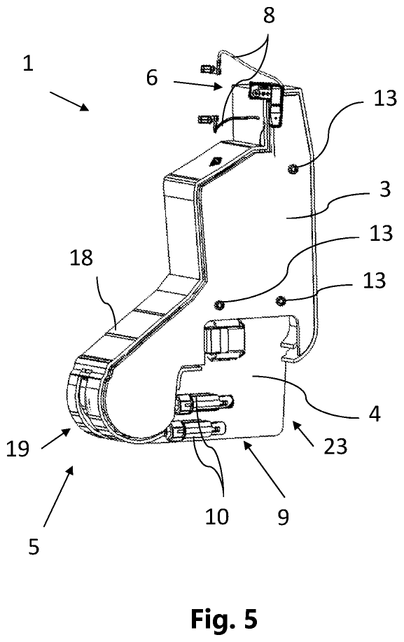

With reference to FIG. 5, a detailed perspective view of an exterior rear view assembly 1 according to FIG. 2 is shown.

In the shown example, the sealing side cover 18 is arranged along the perimeter of the core element 4. The sealing side cover 18 is arranged to follow the perimeter of the core element 4 excluding the area designated as the aperture 23. In this way, the aperture 23 enables access to the plug retaining section 9. Furthermore, the sealing side cover 18 exhibits a further aperture in the area of the coupling section 5 that corresponds to the recess 19 in the core element 4. The sealing side cover 18 is configured adapt to multiple radius changes in order to follow the side area of the core element 4. Additionally and according to another embodiment, the sealing side cover 18 can also seal around the entire side area of the core element 4 against the first plate element 2 and second plate element 3, thusly creating sealed volume, wherein fragile or sensitive components, especially electronic components, can be guided and/or housed.

Additionally, the first plate element 2 (not shown) and second plate element 3 comprise at least one fastening element 13 configured to fasten the first plate element 2, the second plate element 3 and the core element 4 in a predetermined position relative to each other. In the shown example, the assembly comprises three fastening elements 13 depicted as screws. The fastening elements 13 are configured to firmly fasten the first plate element 2, second plate element 3 and core element 4 creating a rigid structure.

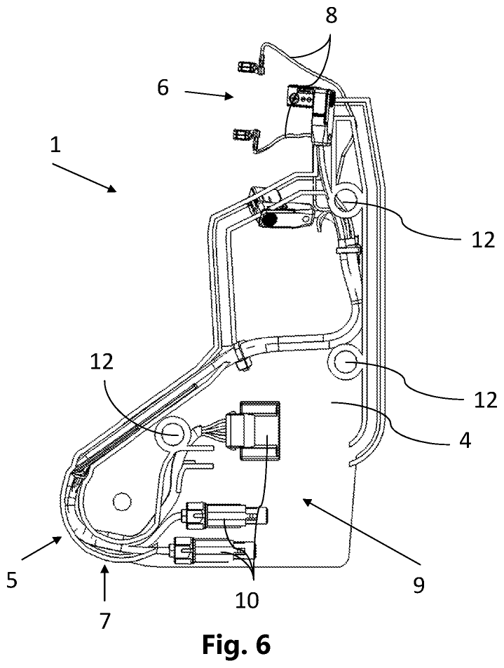

With reference to FIG. 6, a detailed top view of an exterior rear view assembly 1 according to FIG. 2 is shown.

In the shown example, in order to show the underlying components in their entirety, the first plate element 2 and second plate element 3 has been removed. As can be seen, the core element 4 comprises an integral wiring guide 7, which guides a cable harness 8 from the coupling section 5 or plug retention area 9 to the carrier section 6. Additionally, three plugs 10 are shown in the plug retention area 9. The integral wiring guide 7 initially guides the cable harness 8 from the coupling section 5 or plug retention area 9 along the perimeter (longer side) of the core element 4 towards the centre of the core element 4. In a next step, the cable harness 8 is guided to cross to the opposing longer side and then towards the carrier section 6 in order to electronically contact the electronic rear view sensor 17 (not shown). Additionally, the core element includes three counter centering elements 12, which are configured to interact with the centering element 11 (not shown) of the first plate element 2 and/or second plate element 3. Accordingly, the centering elements 11 and counter centering elements 12 align the first plate element 2, second plate element 3 and core element 4 in a predetermined position relative to each other. The positions of the centering elements 11 and counter centering elements 12 can be designed according to the components housed within the core element 4 or the integral wiring guide 7, as to not obstruct them.

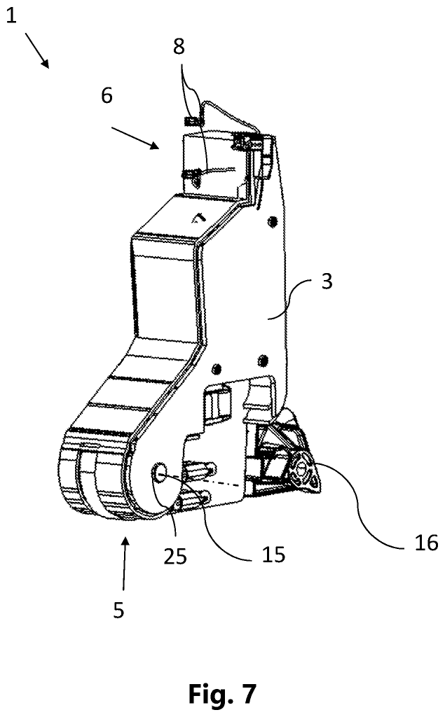

With reference to FIG. 7, a detailed perspective view of an exterior rear view assembly 1 according to another embodiment is shown. The assembly 1 of FIG. 7 is similar to the assembly 1 shown in FIG. 6, with the exception of the articulation axis 15 and intermediary joint 16.

In the shown embodiment, the assembly 1 comprises an intermediary joint 16, which is configured to be in contact with the core element 4. The intermediary joint 16 is displayed as a die casted component with an interface configured to couple the assembly 1 to a vehicle body (not shown). Furthermore, the intermediary joint 16 may provide actuators and/or sensors to actuate the rotation of the assembly 1 or core element 4 around the articulation axis 15. In addition, the intermediary joint 16 may provide an adjustment element, e.g. an excentric element, configured to adjust orientation of the rear view assembly relative to the vehicle body.

The articulation axis 15 is configured as a cylindrical axis located within the coupling section 5 of the assembly 1. In an embodiment, the articulation axis 15 is fixed to the first plate element 2 and/or second plate element 3 and rotatably mounted within the bearing recess 14 (not shown) in the core element 4. The fixation of the articulation axis 15 with the first plate element 2 and/or second plate element 3 is realized by means of an engineered fit. The engineered fit is between the knurled surfaces of articulation axis 15 and apertures 24, 25 in the first plate element 2 and/or second plate element 3 respectively. The assembly 1 can additionally employ bushings (not shown) to improve the bearing of the articulation axis 15 within the bearing recess 14.

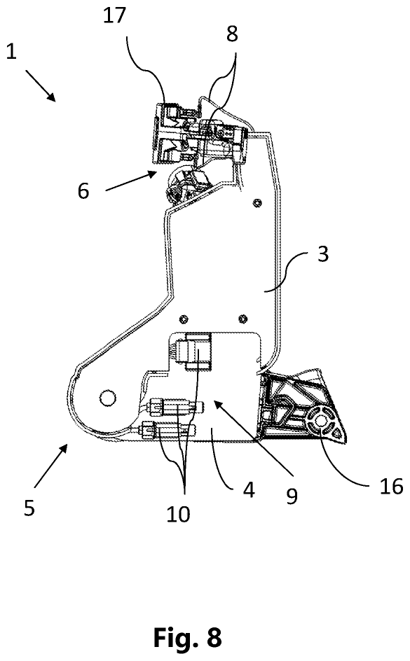

With reference to FIG. 8, a detailed top view of an exterior rear view assembly 1 according to FIG. 7 is shown. In comparison to the assembly 1 depicted in FIG. 7, the assembly of FIG. 8 additionally includes an electronic rear view sensor 17.

In the shown example, the electronic rear view sensor 17 is depicted as a sensor mounted to the carrier section 6 of the core element 4. The electronic rear view sensor 17 is positioned and configured in such a way that it can capture images/video typical to use with road vehicles. Furthermore, the electronic rear view sensor 17 is electronically contacted by the cable harness 8. The cable harness 8 is guided towards the carrier section 6 from the carrier section 5 or plug retention area 9 and ends in plugs 10. Additionally, the positioning of the electronic rear view sensor 17 is specifically chosen to space it from the vehicle body. In this way, electronic view sensor 17 is able to pick up the areas behind and to side of the vehicle.

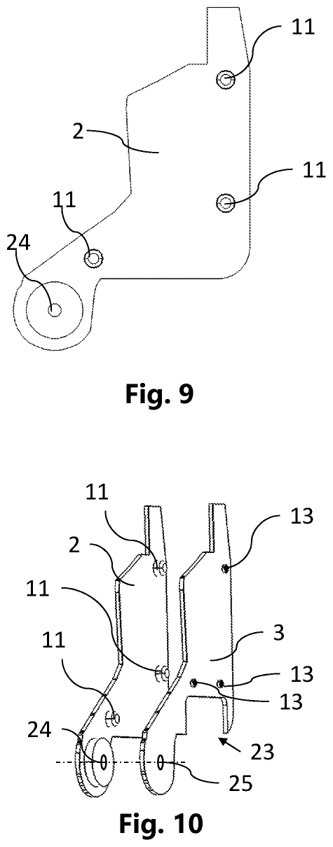

With reference to FIG. 9, a detailed top view of a first plate element 2 is shown.

The first plate element 2 includes three centering elements 11 and an aperture 24. The centering elements 11 are arranged and configured to align with the counter centering elements 12 (not shown) of the core element (not shown) in order to fix the first plate element 2 and the core element 4 in a predetermined position relative to each other. In the shown example, the centering elements 11, which are arranged on the inner surface of the first plate element 3, are configured as pins. Additionally, the amount (three) of centering elements 11 depicted in FIG. 9 is merely exemplary, and can be modified as required. Furthermore, the aperture 24 of the first plate element 2 can be fixed with the articulation axis 15 (not shown) by means of an engineered fit.

With reference to FIG. 10, a perspective view of a first plate element 2 and second plate element 3 is shown. The first plate element 2 is analogous to the first plate element 2 shown in FIG. 9.

The first plate element 2 and second plate element 3 have essentially a similar form, with the exception of the aperture 23 in the second plate element 3. The second plate element 3 includes three fastening elements 13 configured to fixing the first plate element 2, core element 4 (not shown in FIG. 10) and second plate element 3 to each other. The amount of fastening elements 13 is merely exemplary, and can be modified as required. In the shown example, the core element 4 would be arranged between the first plate element 2 and second plate element 3. Additionally, the aperture 24 of the first plate element 2 and aperture of the second plate element 25 are coaxially aligned to receive the articulation axis 15 (not shown). In the shown embodiment, it is possible to initially arrange the first plate element 2, second plate element 3 and core element 4 via the centering elements 11 and counter centering elements 12 (not shown) prior to firmly fixing the joint part with the fastening elements 13.

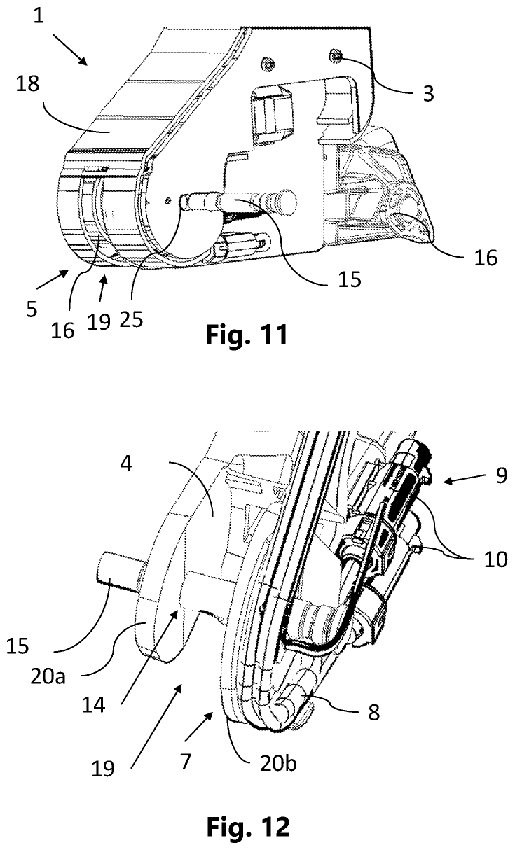

With reference to FIG. 11, a detailed partial view of an exterior rear view assembly 1 according to FIG. 7 is shown. The partial view of the assembly 1 includes approximately half of the assembly 1 between the coupling section 5 and carrier section 6 (not shown).

In the shown example, the articulation axis 15 is coaxial with the aperture 25. For sake of clarity, the articulation axis 15 is depicted outside of the aperture 25 in the manner of an exploded view. The articulation axis 15 exhibits multiple diameter changes along its length in order to interact with the first plate element 2, second plate element 3 and core element 4 individually. Additionally, the extent of the intermediary joint 16 is indicated by the extension of the intermediary joint 16 into the recess 19 of the sealing side cover 18 near the coupling section 5 of the core element 4. The recess 19 is configured to enable the core element 4 to rotate with respect to the articulation axis 15, in order to prevent a collision of the core element 4 and sealing side cover 18 with the intermediary joint 16.

With reference to FIG. 12, a detailed perspective view of an articulation axis 15 and a core element 4 is shown.

As shown in the example, the articulation axis 15 is beared within the recess 19 of the core element 4 by the bearing recess 14. The bearing recess 14 is configured to be in contact with the articulation axis 15 within the sidewalls 20a, 20b of the core element 4. As stated above, bushings (not shown) within the sidewalls 20a, 20b can be utilized to improve the bearing of the articulation axis 15 within the bearing recess 14. The shown example additionally depicts the integral wiring guide 7, which guides the cable harness 8 from the plug retention area 9 along the perimeter of the core element 4. The integral wiring guide 7 is arranged and configured to take into account the bending radii of the cable harness 8 in order to avoid damage of the cable harness 8 and resulting signal loss.

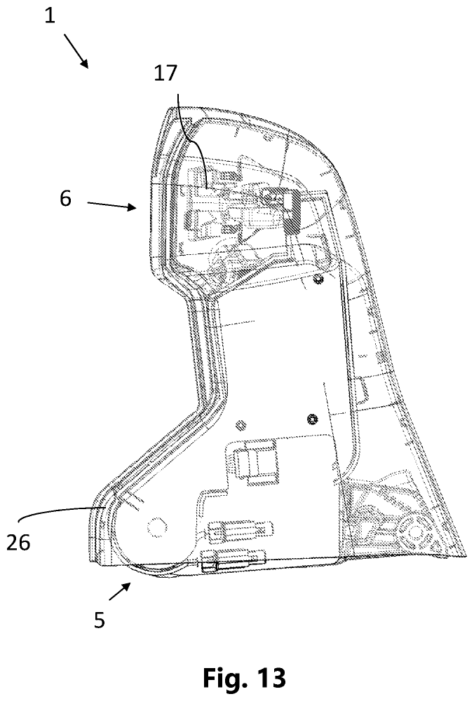

With reference to FIG. 13, a detailed top view of an exterior rear view assembly 1 according to another embodiment is shown.

The assembly 1 includes a cover 26, which encapsulates the underlying components of the assembly 1 as shown in the example. The cover 26 is configured to hide the underlying components from the customer and among other things provide an aerodynamically efficient and aesthetically pleasing appearance. The section of the cover 26 located on the side opposed to the carrier section 6 is configured to be coupled to the vehicle body in an aesthetic manner. Furthermore, the cover 26 can be constructed and designed aerodynamically in order to reduce air resistance of the assembly 1. Additionally, the cover 26 is configured to house an opening and/or see-through component located in close proximity to the carrier section 6. The opening and/or see-through component enables the electric rear view sensor 17 to be able to capture/record the surroundings as desired. The shown contour of the cover 26 is merely exemplary, and can be modified as required or desired.

Although specific embodiments of the invention are illustrated and described herein, it will be appreciated by those of ordinary skill in the art that a variety of alternate and/or equivalent implementations exist. It should be appreciated that the exemplary embodiment or exemplary embodiments are examples only and are not intended to limit the scope, applicability, or configuration in any way. Rather, the foregoing summary and detailed description will provide those skilled in the art with a convenient road map for implementing at least one exemplary embodiment, it being understood that various changes may be made in the function and arrangement of elements described in an exemplary embodiment without departing from the scope as set forth in the appended claims and their legal equivalents. Generally, this application is intended to cover any adaptations or variations of the specific embodiments discussed herein.

It will also be appreciated that in this document the terms “comprise”, “comprising”, “include”, “including”, “contain”, “containing”, “have”, “having”, and any variations thereof, are intended to be understood in an inclusive (i.e. non-exclusive) sense, such that the process, method, device, apparatus or system described herein is not limited to those features or parts or elements or steps recited but may include other elements, features, parts or steps not expressly listed or inherent to such process, method, article, or apparatus. Furthermore, the terms “a” and “an” used herein are intended to be understood as meaning one or more unless explicitly stated otherwise. Moreover, the terms “first”, “second”, “third”, etc. are used merely as labels, and are not intended to impose numerical requirements on or to establish a certain ranking of importance of their objects.

### LIST OF REFERENCE SIGNS

1 assembly
2 first plate element
3 second plate element
4 core element
5 coupling section
6 carrier section
7 wiring guide
8 cable harness
9 plug retaining section
10 plug
11 centring element
12 counter centring element
13 fastening element
14 bearing recess
15 articulation axis
16 intermediary joint
17 electronic rear view sensor
18 sealing side cover
19 recess
20a, 20b sidewall
21 spacer
22 central plane
23 aperture
24 aperture of first plate element
25 aperture of second plate element
26 cover
H1 first thickness
H2 second thickness

1. Exterior rear view assembly for road vehicles, comprising:
a first plate element;
a second plate element having essentially a similar form as and extending essentially in parallel to the first plate element; and
a core element arranged sandwiched between the first plate element and the second plate element,
wherein the first plate element, the core element and the second plate element together form a joint part comprising a coupling section configured to be coupled to a vehicle body in an articulated manner.

2. Exterior rear view assembly according to claim 1, wherein the core element comprises a carrier section configured to carry and electronically contact an electronic rear view sensor.

3. Exterior rear view assembly according to claim 2, wherein the core element comprises an integral wiring guide, in particular a wiring channel, for guiding a cable harness from the coupling section to the carrier section.

4. Exterior rear view assembly according to claim 1, wherein the joint part is configured as cantilever arm that can be articulated and protrude from the coupling section in a vehicle outboard direction such that the electronic rear view sensor is arranged in a position spaced from the vehicle body.

5. Exterior rear view assembly according to claim 1, wherein the core element comprises an integrated plug retaining section configured to fix at least one plug of the cable harness in a predetermined position in the coupling section or in the immediate vicinity of the coupling section.

6. Exterior rear view assembly according to claim 1, wherein the core element comprises a sealing side cover covering an outer side area of the core element.

7. Exterior rear view assembly according to claim 6, wherein the sealing side cover is configured as a sealing barrier extending around the perimeter of the core element and sealing against the first plate element and the second plate element such that the core element is sealed against an exterior environment.

8. Exterior rear view assembly according to claim 7, wherein the sealing side cover, first plate element and second plate element create a sealed internal cavity.

9. Exterior rear view assembly according to claim 1, wherein at least one of the first and second plate elements comprises at least one centering element and the core element comprises at least one counter centering element, wherein the centering and counter centering elements are arranged and configured to align the first plate element and/or second plate element with the core element in a predetermined position relative to each other.

10. Exterior rear view assembly according to claim 1, wherein at least one of the first and second plate elements comprises at least one fastening element configured to fasten the first plate element, the second plate element and the core element in a predetermined position relative to each other.

11. Exterior rear view assembly according to claim 1, wherein the core element comprises a bearing recess arranged in the coupling section, and/or wherein the coupling section comprises an articulation axis (15) protruding from the first plate element or second plate element into the core element, wherein the articulation axis in particular is fixed to or formed integrated with the first plate element or second plate element.

12. Exterior rear view assembly according to claim 1, wherein first plate element and/or second plate element comprises a shielding metal material, in particular aluminium.

13. Exterior rear view assembly according to claim 1, wherein the core element is formed as a hollow body, in particular comprising reinforcing ribs.

14. Method of manufacturing an exterior rear view assembly for road vehicles, in particular an exterior rear view assembly according to claim 1, comprising the steps of:
arranging a core element on a first plate element in a predetermined position relative to the first plate element;
guiding a cable harness by means of an integral wiring guide of the core element from a coupling section of the core element, which is configured to be coupled to a vehicle body, to a carrier section of the core element, which is configured to carry and electronically contact an electronic rear view sensor;
arranging a second plate element on the core element in a predetermined position relative to the core element; and
stiffly fixing the first plate element, core element and second plate element to each other.

15. Method according to claim 14, further comprising
fixing at least one plug of the cable harness in an integrated plug retaining section of the core element in a predetermined position.

16. Method according to claim 14, wherein
arranging the core element on the first plate element and/or arranging the second plate element on the core element comprises pre-fixing the core element and the plate element by means of a clip connection, and/or
stiffly fixing the first plate element, core element and second plate element comprises fixing them to each other with a plurality of fastening elements.
